(19) United States
(12) Patent Application Publication
(10) Pub. No.: US 2026/0001300 A1
(43) Pub. Date: Jan. 1, 2026

(54) OUTER LAYER-COVERED PRODUCT

(71) Applicant: Japan Plastics Technologies Co., Ltd., Aichi (JP)

(72) Inventors: Michikazu SHIMA, Aichi (JP); Mamoru YOKOYAMA, Aichi (JP)

(73) Assignee: Japan Plastics Technologies Co., Ltd., Aichi (JP)

(21) Appl. No.: 19/101,786

(22) PCT Filed: Aug. 11, 2023
(86) PCT No.: PCT/JP2023/029382

§ 371 Date: Feb. 6, 2025

(30) Foreign Application Priority Data
Aug. 15, 2022 (JP) 2022-129367

(51) Int. Cl. B32B 5/18; B32B 3/26; B32B 3/30; B32B 7/09; B32B 27/06

(52) U.S. Cl. CPC B32B 5/18; B32B 3/266; B32B 3/30; B32B 7/09; B32B 27/065; B32B 2250/03; B32B 2266/0214; B32B 2307/7376

(57) ABSTRACT

A skin-coated product is characterized in that it has a base material having a groove of 2.0 mm to 6.0 mm and vacuum holes for vacuum forming formed at predetermined intervals in the bottom of the groove, and an outer skin which is coated on the base material so that an outer skin groove is formed in the groove by vacuum forming. The feature is that the skin is covered with the base material so that the skin groove is formed in the groove by vacuum forming. By adopting such a configuration, since the grooves are formed in the base material used and the grooves have vacuum holes for vacuum forming, the skin is formed so that the skin is sucked into the grooves by vacuum forming, and the grooves are formed in the skin at the groove-formed portion of the base material.

### TECHNICAL FIELD

The present invention relates to an outer layer-covered product in which a base material including plastic, wood, and other hard materials is covered with an outer layer provided with a sewing pattern.

### BACKGROUND ART

In an outer layer-covered product in which a base material is covered with an outer layer, there is a product in which a joint (seam) of two outer layers is expressed as one of stitch designs by sewing together and then covering two outer layers. For example, a technique has been proposed in which an external layer sheet including leather and a slab sheet provided on a back surface side of the external layer sheet are sewn together along outer peripheral edges of the sheets by annular edge overcasting to form an outer layer sheet, and a plurality of outer layer sheets is sewn together by stitches at the outer peripheral edges to form a bag-shaped outer layer for a headrest (Patent Literature 1).

However, in order to join the outer layers together in this manner, a step of processing the outer layers is required, and thus there is a problem that it takes time and cost.

### CITATIONS LIST

### Patent Literature

Patent Literature 1: JP 2007-289284 A

### SUMMARY OF INVENTION

### Technical Problems

Therefore, the present invention has been made to solve the above problems, and an object of the present invention is to provide an outer layer-covered product that can show an appearance as if a seam of an outer layer is formed by covering a base material with one outer layer by vacuum molding.

### Solutions to Problems

In order to solve the above problems, the present invention employs the following means.

An outer layer-covered product of the present invention includes
a base material including a groove of 2.0 mm to 6.0 mm and vacuum holes for vacuum molding, the vacuum holes being formed at predetermined intervals on a bottom surface of the groove, and
an outer layer that covers the base material such that an outer layer groove is formed in the groove by vacuum molding.

In the outer layer-covered product of the present invention, the groove is formed in the base material to be used. Since the groove has the vacuum hole for vacuum molding, the outer layer is formed to be sucked into the groove by vacuum molding, and the groove is also formed in the outer layer at a portion of the base material where the groove is formed. This groove can express as if the two outer layers are sewn together.

In the outer layer-covered product of the present invention, sewing patterns may be formed along the outer layer groove on both sides of the outer layer groove.

In general, decorative stitching is performed on both sides of sewing of leather to enhance decorativeness. In the present invention, sewing patterns are provided in advance on both sides of the position where the outer layer groove is provided, and a decorative stitch can be formed along the outer layer groove when the base material is covered by vacuum molding.

Furthermore, in the outer layer-covered product of the present invention, a wide portion and a narrow portion may be alternately formed in the groove of the base material.

By adopting such a configuration, the wide portion and the narrow portion are alternately formed in the outer layer groove of the outer layer-covered product after vacuum molding. Therefore, when the outer layer is sewn with a thread, a portion of a thread hole and the other portions that are tightly tightened can be expressed, and a form of sewing of the outer layer can be better expressed.

Furthermore, in the outer layer-covered product of the present invention, a portion with a gap and a portion without a gap may be alternately formed in the outer layer disposed in the groove of the base material.

When a wide portion and a narrow portion are alternately formed in the outer layer groove after vacuum molding, the narrow portion is formed so as not to form a gap, and the wide portion is designed so as to form a gap. Accordingly, the form of sewing of the outer layer can be expressed even better.

Furthermore, in the outer layer-covered product of the present invention, the vacuum holes may be formed at a pitch of 3.0 mm to 5.0 mm on the bottom surface of the groove.

By forming the vacuum holes at a pitch of 3.0 mm to 5.0 mm on the bottom surface of the groove, the vacuum holes can be firmly drawn into the groove of the base material to form the groove in the outer layer.

Furthermore, in the outer layer-covered product of the present invention, the outer layer may have a thickness of 2.0 mm to 4.0 mm, and include a laminate of a soft plastic resin and a foamed resin.

The wide and narrow portions of the outer layer groove of the outer layer can be easily expressed since a foamed resin is included.

### BRIEF DESCRIPTION OF DRAWINGS

FIG. 1 is a front view of an outer layer-covered product 100 according to an embodiment.

FIG. 2 is a front view of a base material 10 of the outer layer-covered product 100 according to the embodiment.

FIG. 3 is a sectional view of the base material 10 of the outer layer-covered product 100 according to the embodiment.

FIG. 4 is an enlarged view of a portion B in FIG. 1 and a portion D in FIG. 2.

FIG. 5 is a flowchart illustrating a preparation step of preparing the outer layer-covered product 100 according to the embodiment.

FIG. 6 is a front view of a sewing pattern of an outer layer according to the embodiment.

FIG. 7 is an explanatory diagram describing a state of forming a groove 11 of the outer layer-covered product 100 according to the embodiment.

### DESCRIPTION OF EMBODIMENT

Hereinafter, an outer layer-covered product according to an embodiment will be described in detail with reference to the drawings. Note that the embodiment and drawings described below illustrate a part of the embodiment of the present invention, are not used for the purpose of limiting to the configurations of the embodiment, and can be appropriately changed without departing from the gist of the present invention. In the drawings, corresponding constituent elements are denoted by the same or similar reference signs.

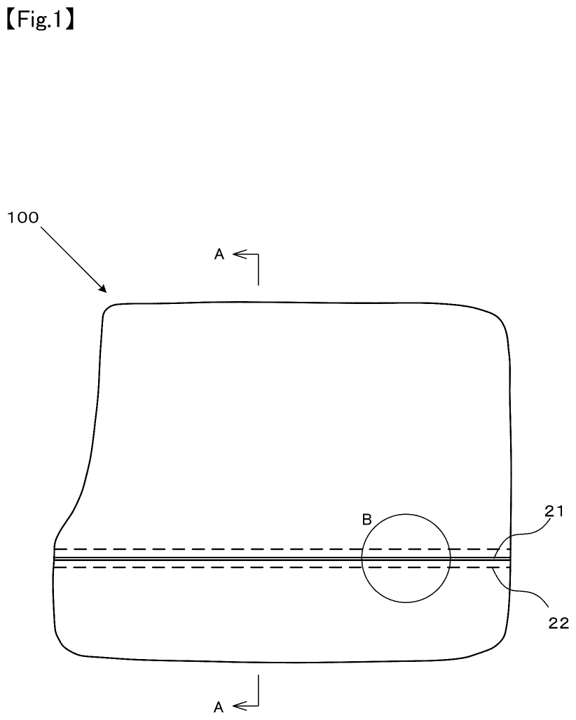

As illustrated in FIGS. 1 to 3, an outer layer-covered product 100 of the present invention includes a base material 10 and an outer layer 20 coated on the base material 10 by vacuum molding.

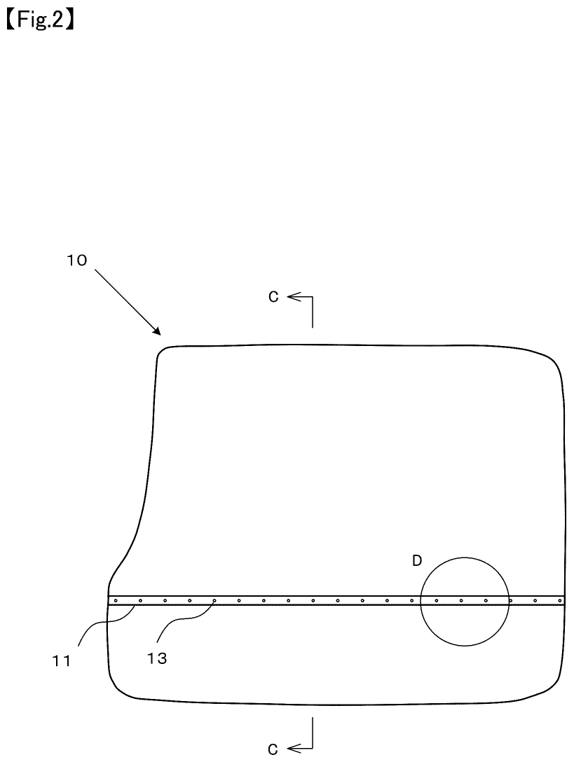

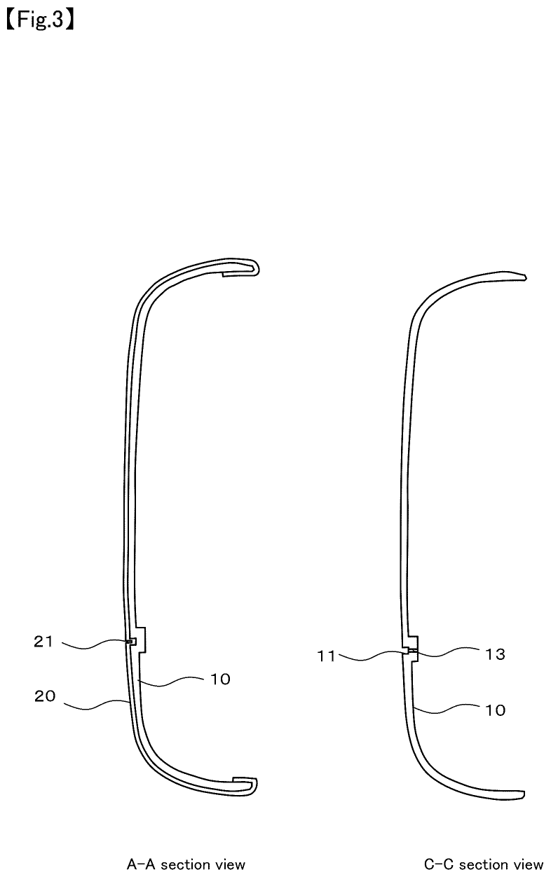

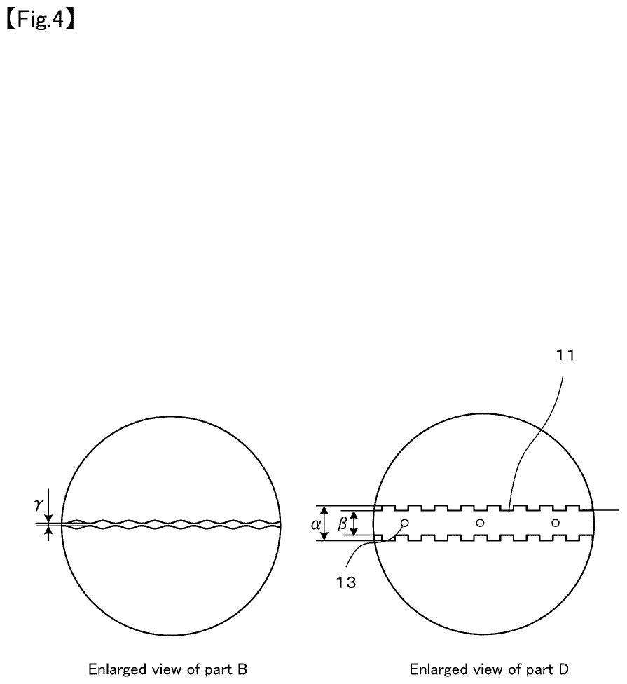

As illustrated in FIGS. 2 and 3, the base material 10 is a plate-like member prepared with plastic, and a form of the base material 10 is not limited, and an outer shape and a surface of the base material 10 are formed in accordance with a component to be used. The base material 10 has a groove 11 formed at a position where a seam provided by sewing the outer layer 20 together is desired to be provided when the base material becomes a final product. The groove 11 is formed to have a width of 2.0 mm to 6.0 mm and a depth of about 2.0 mm to 8.0 mm. On a bottom surface of the groove 11, vacuum holes 13 penetrating the base material at a pitch of 5.0 mm to 10.0 mm along a longitudinal direction are prepared. As illustrated in FIG. 2, the groove 11 may be formed in grooves having the same width. However, preferably, as illustrated in an enlarged view of a portion D in FIG. 4, the groove 11 is formed such that wide portions a and narrow portions β are alternately generated, and irregularities are formed on side surfaces of the groove 11. By molding by using such a base material 10, wide portions and narrow portions are formed in the outer layer 20 as illustrated in an enlarged view of a portion B in FIG. 4, and it is possible to show an appearance as if actually sewn together with a thread. The wide portions α and the narrow portions β can be set in accordance with the outer layer 20 to be used. For example, it is preferable to form the wide portions of 4.6 mm and the narrow portions of 4.0 mm. Of course, the present invention is not limited to the above, and for example, the wide portions can be adjusted to 4.3 mm or 4.9 mm. In particular, when the outer layer is covered by vacuum molding in accordance with a thickness of the outer layer 20, it is preferable to form the narrow portions so that a width γ of the narrow portions is as narrow as possible, and more preferably a width of an outer layer groove 21 is eliminated, that is, the outer layer 20 of the outer layer groove 21 is in contact with each other, as illustrated in the enlarged view of the portion B in FIG. 4. By forming in this manner, it is possible to more accurately reproduce the form when the outer layer 20 is actually joined by a sewing machine.

The outer layer 20 is not limited as long as the outer layer 20 is usable for vacuum molding. A laminate of a soft plastic resin and a foamed resin is preferably used in order to easily form wide and narrow portions in the outer layer groove 21 when the outer layer groove 21 is formed. The outer layer 20 may be provided with a sewing pattern 22 such that stitches are formed on both sides of a portion where the outer layer groove 21 is formed.

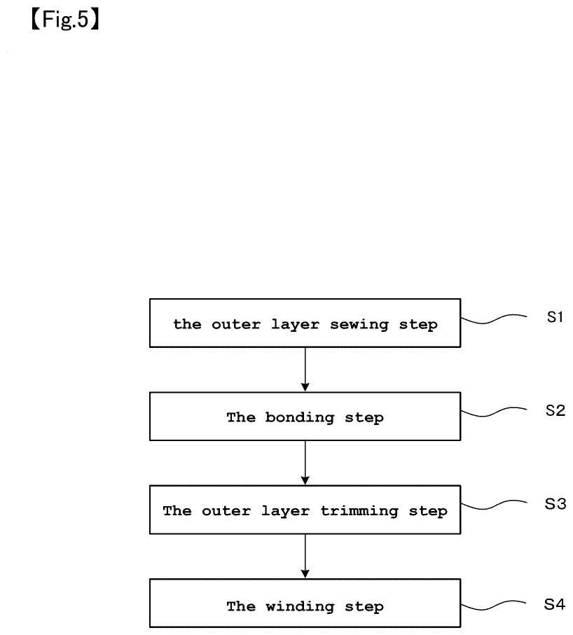

Next, a method of preparing the outer layer-covered product 100 of the present invention will be described. As illustrated in FIG. 5, the method of preparing the outer layer-covered product 100 mainly includes (1) an outer layer sewing step (S1) of sewing the sewing pattern 22 in a raw fabric of the outer layer 20, (2) a bonding step (S2) of bonding the outer layer 20 to the base material 10 by vacuum molding, (3) an outer layer trimming step (S3) of cutting a periphery of the outer layer in accordance with the form of the base material 10, and (4) a winding step (S4) of winding the outer layer 20 after the outer layer trimming step. Hereinafter, each step will be described in detail.

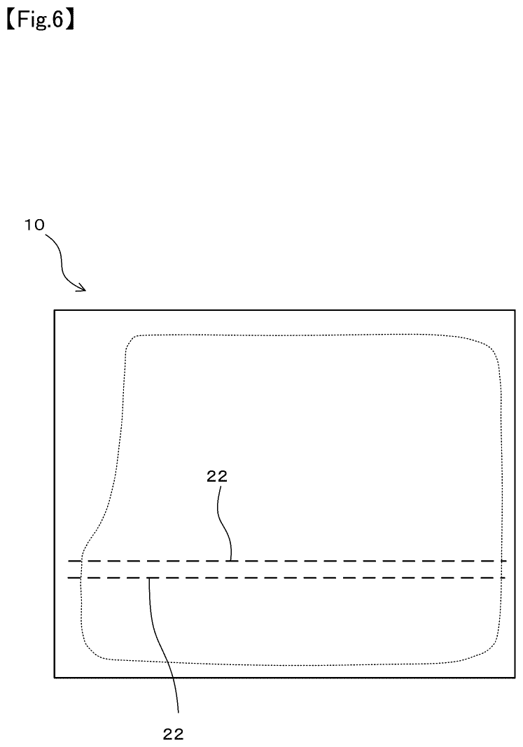

As illustrated in FIG. 6, the outer layer sewing step (S1) is a step of sewing the sewing pattern 22 for decoration to the outer layer 20 that is unmolded and planar. The fine dotted line in FIG. 6 virtually indicates a range in which the base material 10 is disposed, and the dotted line is not actually indicated. The sewing pattern 22 is a decorative stitch formed on both sides of a sewn portion, and is provided in parallel at a distance of about 5.0 mm to 10.0 mm on both sides of the portion where the outer layer groove 21 is formed. The sewing pattern 22 is not limited to one-line sewing, two-line sewing, and the like. In a case where the decorative stitch is not provided, this step may be omitted.

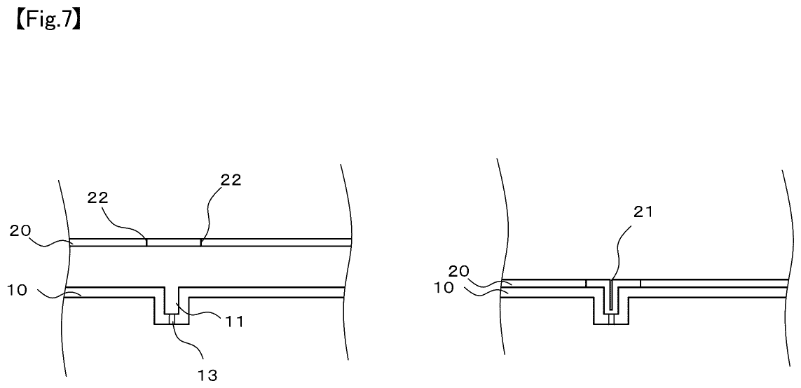

The bonding step (S2) is a step of bonding the outer layer 20 to the base material 10 and covering the base material 10 with the outer layer 20 by vacuum molding, and in the present invention, the step of molding the outer layer 20 and the bonding step are performed simultaneously. Specifically, the outer layer 20 is fixed to a bonding surface side of the base material 10. Next, the outer layer 20 is heated by a heater. As a result, the outer layer 20 becomes flexible and easily follows a surface of the base material 10. Then, the outer layer 20 is drawn by vacuuming a back surface side of the base material 10, and the outer layer 20 is bonded to the surface of the base material 10 while being molded into the form of the base material 10. At this time, as illustrated in FIG. 7, the portion of the groove 11 of the base material 10 is drawn by the vacuum hole 13 formed in the groove 11 to form the outer layer groove 21.

The outer layer trimming step (S3) is a step of cutting an extra portion of the outer layer 20 bonded to the base material 10 and separating a plurality of the outer layers simultaneously molded and bonded into individual outer layer. The outer layer trimming step may be performed by machining.

The winding step (S4) is a step of winding and fixing the outer layer 20 protruding around the base material 10 to a rear side. The wound outer layer 20 is bonded to the rear side of the base material 10 with an adhesive or fixed by a stapler or the like.

The outer layer-covered product 100 is thus completed. The completed outer layer-covered product 100 can form the outer layer groove 21 as if the outer layer 20 is sewn together, although only one outer layer was covered by vacuum molding. In a case of using the outer layer 20 provided with the sewing pattern 22 sewn before molding on both sides of the outer layer groove 21, the decorative stitches can be formed on both sides of the seam of the outer layer 20. Since the narrow portions and the wide portions are formed in the outer layer by using the groove 11 produced so that the wide portions a and the narrow portions β are alternately generated, it is possible to more accurately reproduce the form when the outer layer 20 is actually joined by the sewing machine.

As the outer layer-covered product 100, automobile related parts such as a door trim, an armrest, an ornament, and a console lid, furniture such as a chair and a desk, and the like can be considered, but the present invention is not limited thereto, and any product may be used as long as the product functions as a product to which an outer layer is bonded.

Note that the present invention is not limited to each embodiment described above at all, and it goes without saying that the present invention can be implemented in various modes as long as falling within the technical scope of the present invention.

### INDUSTRIAL APPLICABILITY

As illustrated in the above embodiment, the present invention can be industrially used as a method of making an automobile-related component.

### REFERENCE SIGNS LIST

10 base material
11 groove
13 vacuum hole
20 outer layer
21 outer layer groove
22 sewing pattern.
100 outer layer-covered product

1. An outer layer-covered product comprising:
a base material including a groove of 2.0 mm to 6.0 mm and vacuum holes for vacuum molding, the vacuum holes being formed at predetermined intervals on a bottom surface of the groove; and
an outer layer that covers the base material such that an outer layer groove is formed in the groove by vacuum molding.

2. The outer layer-covered product according to claim 1, wherein sewing patterns are formed along the outer layer groove on both sides of the outer layer groove.

3. The outer layer-covered product according to claim 1, wherein a wide portion and a narrow portion are alternately formed in the groove of the base material.

4. The outer layer-covered product according to claim 3, wherein a portion with a gap and a portion without a gap are alternately formed in the outer layer disposed in the groove of the base material.

5. The outer layer-covered product according to claim 1, wherein the vacuum holes are formed at a pitch of 3.0 mm to 5.0 mm.

6. The outer layer-covered product according to claim 1, wherein the outer layer has a thickness of 2.0 mm to 4.0 mm, and includes a laminate of a soft plastic resin and a foamed resin.

7. The outer layer-covered product according to claim 2, wherein the vacuum holes are formed at a pitch of 3.0 mm to 5.0 mm.

8. The outer layer-covered product according to claim 3, wherein the vacuum holes are formed at a pitch of 3.0 mm to 5.0 mm.

9. The outer layer-covered product according to claim 4, wherein the vacuum holes are formed at a pitch of 3.0 mm to 5.0 mm.

10. The outer layer-covered product according to claim 2, wherein the outer layer has a thickness of 2.0 mm to 4.0 mm, and includes a laminate of a soft plastic resin and a foamed resin.

11. The outer layer-covered product according to claim 3, wherein the outer layer has a thickness of 2.0 mm to 4.0 mm, and includes a laminate of a soft plastic resin and a foamed resin.

12. The outer layer-covered product according to claim 4, wherein the outer layer has a thickness of 2.0 mm to 4.0 mm, and includes a laminate of a soft plastic resin and a foamed resin.
